(19) United States
(12) Patent Application Publication
(10) Pub. No.: US 2010/0125625 A1
(43) Pub. Date: May 20, 2010

(54) Method for Restricting Usage of a Mobile Device for Participating in a Session

(75) Inventors: Manuel Oliver, Scottsdale, AZ (US); Peter A. Lin, Lisle, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/271,407

(22) Filed: Nov. 14, 2008

(51) Int. Cl. G06F 15/16

(52) U.S. Cl. 709/203

(57) ABSTRACT

A method for facilitating a mobile device to participate in a session hosted on a server is disclosed. In the disclosed method, the mobile device requests the server to permit the mobile device to participate in the session. In response to the request, the mobile device receives a set of restrictions. The set of restrictions comprises one or more restrictions that the mobile device requires to impose on one or more applications residing in the mobile device. The mobile device determines whether to accept or reject the received set of restrictions. Upon determining to accept the restrictions, the mobile device sends an acceptance message to the server, and in response, the server allows the mobile device to access the session hosted on the server.

### FIELD OF THE DISCLOSURE

The present disclosure relates generally to the field of mobile devices and particularly relates to restricting the usage of a mobile device.

### BACKGROUND

Today, mobile devices are widely used in all spheres of modern life. Significant growth in the field of electronics and telecommunication has revolutionized the way we connect to people and avail services at distant places. The mobile devices, particularly mobile phones, are used worldwide for personal as well as business communication. Generally, a person carries a mobile phone most of the times to stay connected with his acquaintances, but sometimes the mobile phone becomes a source of interruption in certain situations and places.

There are many places where usage of a mobile phone is restricted, for example, in educational institutes, theatres, offices, airplanes, high security zones, etc. Moreover, there are certain situations where people themselves want to restrict the usage of their mobile phones, for example, in a classroom, during a seminar, in a meeting, etc. In such places and situations, people are often asked to switch off their mobile phones. By switching off the mobile phone, a person might miss an important call. Therefore, rather than switching off the mobile phones, it is preferable to have a mechanism to restrict the usage of the mobile phone.

Some techniques have been proposed in past for restricting usage of mobile phones. One of those techniques is a method for controlling usage of a mobile terminal based on an authorization code. A usage specification including an identification of allowed numbers, an identification of restricted numbers, a usage time limitation, etc. is specified for the mobile terminal. Usage of the mobile terminal is limited based on the usage specification responsive to receipt of a valid authorization code. The primary use of this technique is for a parent to restrict a child from using the mobile terminal.

Another known technique is a method for managing a mobile phone answering mode and outgoing message based on a location of the mobile phone. This technique employs a location system to ascertain current location of a mobile phone being carried by a user. Based on the current location, it is determined whether operation of the mobile phone to receive and/or send calls should be restricted. In addition, a message is provided to calling parties while the mobile phone is located in an area where use of the mobile telephone to receive calls is prohibited. This technique restricts incoming and/or outgoing calls without asking the user permission. As soon as the user enters a location where calls are to be restricted, the mobile phone automatically restricts reception of the calls.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates a system diagram for mobile devices participating in a session hosted on a server in accordance with some embodiments of the present disclosure.

FIG. 2 is a block diagram illustrating a mobile device of FIG. 1 in accordance with some embodiments of the present disclosure.

FIG. 3 is a block diagram illustrating the server of FIG. 1 in accordance with some embodiments of the present disclosure.

FIG. 4 is a flowchart of a method for facilitating a mobile device to participate in a session hosted on a server, according to an embodiment of the present disclosure.

FIG. 5 is a flowchart of a method for facilitating a server to impose restrictions on a mobile device to enable the mobile device to participate in a session, according to an embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

Before describing in detail embodiments that are in accordance with the present disclosure, it should be observed that the embodiments reside primarily in combinations of method steps and apparatus components related to restricting usage of a mobile device for participating in a session. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the disclosure described herein may be comprised of one or more conventional processors and unique stored program instructions that control the one or more processors to implement, in conjunction with certain non-processor circuits, some, most, or all of the functions for restricting usage of a mobile device for participating in a session described herein. The non-processor circuits may include, but are not limited to, a radio receiver, a radio transmitter, signal drivers, clock circuits, power source circuits, and user input devices. As such, these functions may be interpreted as steps of a method for restricting usage of a mobile device for participating in a session. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation.

All of the embodiments described in this Detailed Description are exemplary embodiments provided to enable persons skilled in the art to make or use the disclosure and not to limit the scope of the disclosure which is defined by the claims.

The present disclosure discloses a method for facilitating a mobile device to participate in a session hosted on a server. In one embodiment, the mobile device requests the server to participate in the session. In response to the request, the mobile receives a set of restrictions from the server. The set of restrictions includes restrictions to be imposed on one or more applications residing in the mobile device. The mobile device determines whether to accept or reject the received set of restrictions. Upon accepting the restrictions, the mobile device sends an acceptance message to the server confirming imposition of the restrictions. Thereafter, the mobile device obtains access to the session hosted on the server.

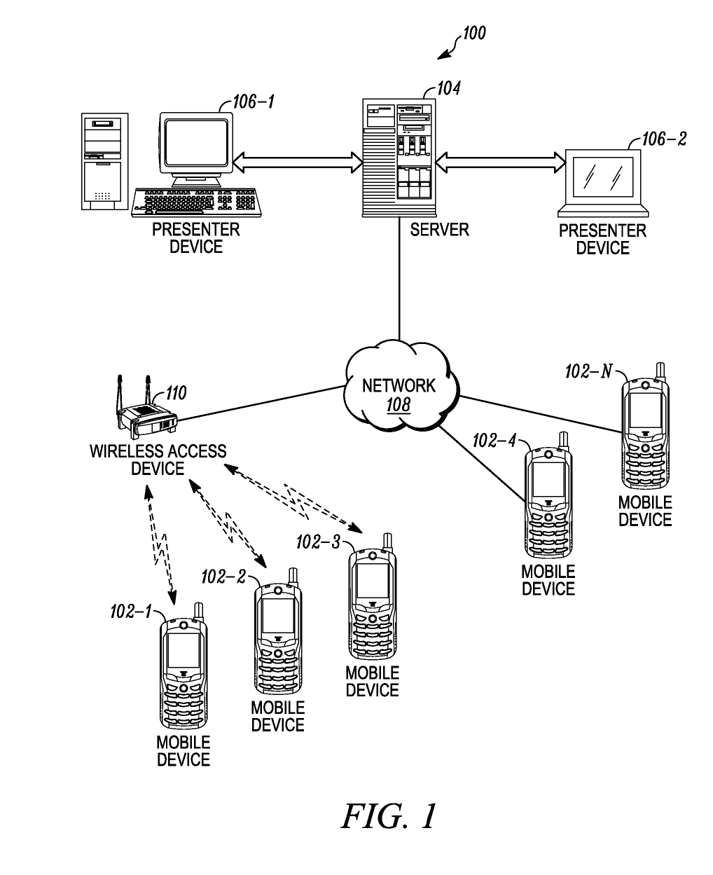

FIG. 1 shows a system 100 having various mobile devices participating in a session hosted on a server. In one embodiment, the system 100 includes a plurality of mobile devices 102-1 to 102-N, collectively referred to as mobile devices 102. The mobile devices 102 include, but not limited to, mobile phones, pagers, Personal Digital Assistants (PDAs), laptops, etc. The system 100 also includes a server 104 that communicates with presenter devices 106-1 and 106-2, collectively referred to as presenter devices 106, for hosting one or more sessions controlled via the presenter devices 106. The presenter devices 106 refer to personal computers or laptops possessed by presenters or instructors conducting the sessions. The mobile devices 102 and the server 104 can communicate with each other via a network 108. The network 108 can be any wired or a wireless network and can include various network devices such as switches, routers, bridges, multiplexers, de-multiplexers, servers, client devices, etc. The mobile devices 102 can connect to the network 108 through either wireless or wired communication links. For example, in the system 100, the mobile devices 102-1 to 102-3 communicate with the server 104 wirelessly by accessing the network 108 via a wireless access point 110, whereas the mobile devices 102-4 to 102-N connect to the network 108 over wired connections.

In one embodiment, the system 100 may refer to a system employed in an educational institute like schools or colleges for imparting education to students. In such a scenario, the mobile devices 102 can be mobile phones, PDAs (Personal Digital Assistants), or laptops carried by the students in a classroom. The server 104 is a server maintained by the educational institute to host educational sessions led by the instructors through the presenter devices 106. Each of the mobile devices 102 carried by the students have capabilities to participate in the session hosted on the server 104. The classroom can have wireless connectivity or individual wired connections for the mobile devices 102. A student can also participate in the session without being present in the classroom, if the student has connectivity to the network 108 to access the server 104.

The students using their respective mobile devices can receive invitation alert from the presenter and can send request messages to the server 104 to participate in a session hosted on the server 104 by a presenter device, for example, the presenter device 106-1. The server 104 sends a set of restrictions to the mobile devices 102 before providing access to the session. The mobile devices 102 may accept or reject the restrictions based upon discretion of respective students carrying the mobile devices 102. One or more of the mobile devices 102 accepting the restrictions sends an acceptance message(s) to the server 104, and in response obtains access to the session hosted on the server 104.

In alternate embodiments, the system 100 can refer to a system employed in a multinational organization for conducting a conference, a meeting, or a seminar with participants present at different office locations.

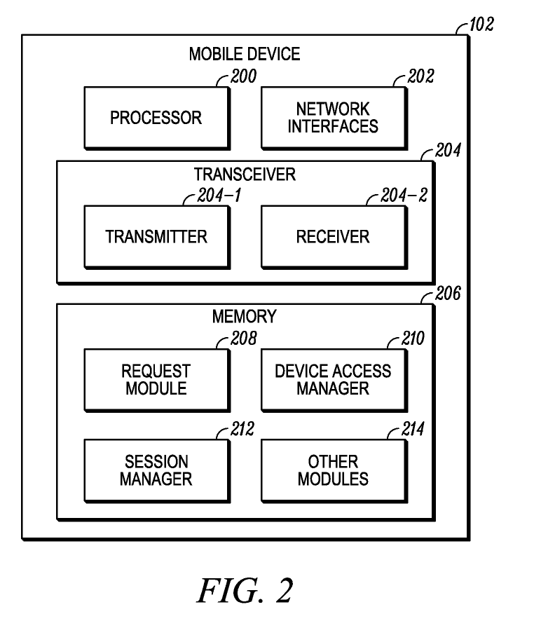

FIG. 2 is a block diagram illustrating various components of the mobile device 102. In one embodiment, the mobile device 102 includes a processor 200, one or more network interfaces 202 for establishing connection with the server 104 and other mobile devices present in the system 100, a transceiver 204, and a memory 206 for storing operating instructions that are executed by the processor 200. Although not shown, the mobile device 102 also can include an antenna, a duplexer, a circulator, or other highly isolative means for intermittently providing data from the transceiver 204 to the antenna and from the antenna to the transceiver 204. The mobile device 102, for example, can be an integrated unit containing at least all the elements depicted in FIG. 2, as well as any other elements necessary for the mobile device 102 to perform its particular functions.

The processor 200 includes one or more microprocessors, microcontrollers, DSPs (Digital Signal Processors), state machines, logic circuitry, or any other device or devices that process information based on operational or programming instructions. Such operational or programming instructions are stored in the memory 206. The memory 206 can be an IC (Integrated Circuit) memory chip containing any form of RAM (Random Access Memory) or ROM (Read-Only Memory), a floppy disk, a CD-ROM (Compact Disk Read-Only Memory), a hard disk drive, a DVD (Digital Video Disc), a flash memory card or any other medium for storing digital information. One of ordinary skill in the art will recognize that when the processor 200 has one or more of its functions performed by a state machine or logic circuitry, the memory 206 containing the corresponding operational instructions can be embedded within the state machine or logic circuitry.

The transceiver 204 includes a transmitter 204-1 and a receiver 204-2. The transceiver 204 enables the mobile device 102 to communicate with the server 104 and other devices in the network 108. In this regard, the transmitter 204-1 and the receiver 204-2 include conventional circuitry to enable digital or analog transmissions over a wireless communication channel. The transceiver 204 is designed to operate over air interface such as 802.11 WLAN (Wireless Local Area Network), 802.16 WiMax (Worldwide Interoperability for Microwave Access), and the like. It is to be understood that the mobile device 102 can communicate with the server 104 over a wired connection and through appropriate interfaces such as a USB port (Universal Serial Bus).

The transmitter 204-1 can be designed to allow transmitting to multiple devices on multiple frequency bands. The receiver 204-2 is designed to allow receiving of radio frequency (RF) signals from within at least one bandwidth and optionally more bandwidths, if the communications with the proximate device are in a frequency band other than that of the network communications.

The implementations of the transmitter 204-1 and the receiver 204-2 depend on the implementation of the mobile device 102. For example, the transmitter 204-1 and the receiver 204-2 can be implemented as an appropriate wireless modem, or as conventional transmitting and receiving components of two-way wireless communication devices. Most, if not all, of the functions of the transceiver 204 can be implemented in a processor, such as the processor 200.

The memory 206 includes various modules containing instructions for functioning of the mobile device 102. The functioning of the mobile device 102 is explained using the modules to facilitate better understanding; however, these modules do not limit implementation various embodiments disclosed in the present disclosure.

In one embodiment, the memory 206 includes a request module 208, a device access manager 210, a session manager 212, and other modules 214 such as operating system, application support software, and other similar modules that assist in proper functioning of the mobile device 102.

The request module 208 enables the mobile device 102 to request the server 104 for participating in a session hosted on the server 104. In one embodiment, the request module 208 sends a request message to the server 104, requesting the server 104 to allow the mobile device 102 to participate in the session. The mobile device 102 can send the request message as a text message via Short Message Service (SMS) or e-mail. The mobile device 102 can also request the server 104 via voice communication or an IVRS (Interactive Voice Response System). In response to the request message, the mobile device 102 receives an authentication message from the server 104, directing the mobile device 102 to send credentials of a user carrying the mobile device 102. In response to the authentication message, the request module 208 sends the credentials of the user to the server 104. The credentials can include, for example, a username and a password, or biometric information of the user. In one embodiment, the mobile device 102 and the server 104 mutually authenticate each other, where the mobile device 102 verifies the server 104 based on a server ID, or the like. After authentication, the request module 208 informs the device access manager 210 about completion of authentication process.

The device access manager 210 manages access to applications residing in the mobile device 102 based on a set of restrictions received from the server 104. Upon successful authentication, the mobile device 102 receives a set of restrictions from the server 104. The user of the mobile device 102 reviews the received set of restrictions and decides whether to accept the restrictions. The device access manager 210 analyzes the decision of the user and responds to the server 104 accordingly. In case the user decides to reject the restrictions, the device access manager 210 sends a rejection message to the server 104 and terminates any further communication with the server 104. However, if the user decides to accept the restrictions, the device access manager 210 analyzes the set of restrictions and imposes the restrictions on the mobile device 102, thereby restricting the use of one or more applications residing in the mobile device 102. After imposing restrictions on the mobile device 102, the device access manager 210 sends an acceptance message to the server 104, confirming the imposition of the restrictions on the mobile device 102. Thereafter, the mobile device 102 receives an authorization message from the server 104, thereby providing access to the session to the mobile device 102. After receiving the authorization message, the device access manager 210 informs the session manager 212 that access to the session is available.

The session manager 212 manages communication with the server 104 during the session as well as when the session is temporarily terminated. The session manager 212 receives various messages from the server 104 during the session. The messages can include questions, surveys, lectures, etc. In one embodiment, the session manager 212 provides a graphical user interface (GUI) for viewing multimedia presentations shared by an instructor leading the session through the server 104. The session manager 212 also enables the user to send responses to the messages received from the server 104. The session manager 212 may also have an option to store the messages and the presentations received from the server 104 for future reference. Based on a request from the user, the session manager 212 can ask the device access manager 210 to disable the access to the session, and thereby remove the restrictions imposed on the mobile device 102.

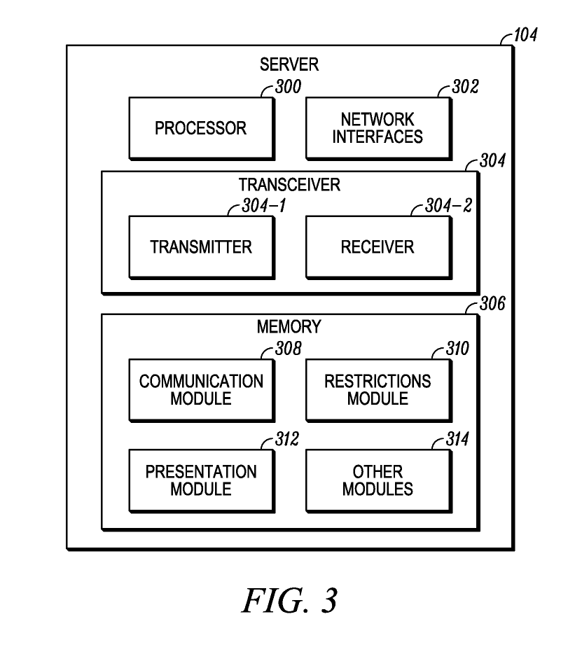

FIG. 3 is a block diagram illustrating components of the server 104 in accordance with some embodiments of the present disclosure. In one embodiment, the server 104 includes a processor 300, one or more network interfaces 302, a transceiver 304, and a memory 306 for storing operating instructions that are executed by the processor 300. Although not shown, server 104 also can include an antenna, a duplexer, a circulator, or other highly isolative means for intermittently providing data from the transceiver 304 to the antenna and from the antenna to the transceiver 304. The server 104, for example, can be an integrated unit containing at least all the elements depicted in FIG. 3, as well as any other elements necessary for the server 104 to perform its particular functions.

The processor 300 includes one or more microprocessors, microcontrollers, DSPs (Digital Signal Processors), state machines, logic circuitry, or any other device or devices that process information based on operational or programming instructions. Such operational or programming instructions are stored in the memory 306. The memory 306 can be an IC (Integrated Circuit) memory chip containing any form of RAM (Random Access Memory) or ROM (Read-Only Memory), a floppy disk, a CD-ROM (Compact Disk Read-Only Memory), a hard disk drive, a DVD (Digital Video Disc), a flash memory card or any other medium for storing digital information. One of ordinary skill in the art will recognize that when the processor 300 has one or more of its functions performed by a state machine or logic circuitry, the memory 306 containing the corresponding operational instructions can be embedded within the state machine or logic circuitry.

The transceiver 304 includes a transmitter 304-1 and a receiver 304-2. The transceiver 304 enables the server 104 to communicate with mobile devices 102 and other devices in the network 108. In this regard, the transmitter 304-1 and the receiver 304-2 include conventional circuitry to enable digital or analog transmissions over a wireless communication channel. The transceiver 304 is designed to operate over air interface such as 802.11 WLAN (Wireless Local Area Network), 802.16 WiMax (Worldwide Interoperability for Microwave Access), LTE (Long Term Evolution) and the like. It is to be understood that the server 104 can communicate with the mobile devices 102 over wired connection as well.

The transmitter 304-1 can be designed to allow transmitting to multiple devices on multiple frequency bands. The receiver 304-2 is designed to allow receiving of radio frequency (RF) signals from within at least one bandwidth and optionally more bandwidths, if the communications with the proximate device are in a frequency band other than that of the network communications.

The implementations of the transmitter 304-1 and the receiver 304-2 depend on the implementation of the server 104. For example, the transmitter 304-1 and the receiver 304-2 can be implemented as an appropriate wireless modem, or as conventional transmitting and receiving components of two-way wireless communication devices. Most, if not all, of the functions of the transceiver 304 can be implemented in a processor, such as the processor 300.

The memory 306 includes various modules containing instructions for functioning of the server 104. The functioning of the server 104 is explained using the modules to facilitate better understanding; however, these modules do not limit various embodiments of techniques disclosed in the present disclosure.

In one embodiment, the memory 306 includes a communication module 308, a restriction module 310, a presentation module 312, and other modules 314 such as operating system, application support software, database, and the like.

The communication module 308 communicates with the mobile devices 102 to address any requests made by the mobile devices 102 either before participating in the session or during the session. The communication module 308 receives a request message from a mobile device, for example, mobile device 102-1, for participating in the session hosted on the server 104. In response to the received request message, the communication module 308 sends an authentication message to the mobile device 102-1. The authentication message includes queries to authenticate or verify the credibility of a user carrying the mobile device 102-1. For example, the communication module 308 sends queries directed to credentials of the user such as username, password, etc. The communication module 308 authenticates the user based on a response it receives from the mobile device 102-1. After authentication, the communication module informs the restrictions module 310 about the request from the mobile device 102-1. In an alternate embodiment, the communication module 308 sends invitation alert to the mobile device 102-1 to participate in the session. Such a scenario may occur if the server 104 holds regular and timely sessions and maintains a list of mobile devices that are enrolled for the sessions. In such a case, before initiating the session, the communication module 308 informs each of the enrolled mobile devices about the session by sending invitation alerts.

The restrictions module 310 manages restrictions for the mobile devices 102 participating in the session. In one embodiment, the restrictions module 310 receives a message from the communication module 308, informing the restrictions module 310 that the mobile device 102-1 has requested to participate in the session. The restrictions module 310 determines the type of session currently hosted on the server 104, and accordingly prepares a set of restrictions. Restrictions can differ for different types of sessions. For example, a session including examination questions may require restrictions on usage of camera, audio-video player, internet access, and voice communication of the mobile device 102-1, whereas a session including a multi-media presentation may require the usage of audio-video player of the mobile device 102-1. Some of the restrictions that the restrictions module 310 can include in the set of restrictions are:
restricting voice communications to emergency calls only or a limited subset (such as family members),
restricting messaging communications to one address (such as website hosted in the server) or a limited number of addresses,
restricting access to the Internet,
restricting use of media capture (camera/video) or playback,
restricting use of applications such as music player, games, and the like.

After determining the set of restrictions, the restrictions module 310 sends a message including the set of restrictions to the mobile device 102-1. The restrictions module 310 awaits an acceptance message from the mobile device 102-1 that confirms imposition of the restrictions on the mobile device 102-1. After receiving the acceptance message from the mobile device 102-1, the restrictions module 310 sends an authorization message to the mobile device 102-1, thereby permitting the mobile device 102-1 to participate in the session hosted on the server 104. In one embodiment, the authorization message includes a unique identification (ID) for the mobile device 102-1, using which the mobile device 102-1 can log on to the server 104 to participate in the session. The unique ID can be any numeric, alphabetic, alphanumeric code or a combination of two or more such codes. Thereafter, the communication module 310 informs the presentation module 312 about authorized access granted to the mobile device 102-1.

The presentation module 312 selects and presents content for the session, and manages communication between the mobile devices 102 and the server 104 during the session. In one embodiment, the presentation module 312 receives content from presenter devices 106 for the session. The presentation module 312 can also select content from the database included in the other modules 324. The presentation module 312 identifies the mobile device 102-1 logged on to the server 104 based on the unique ID assigned to the mobile device 102-1. The presentation module 312 either can allow the mobile device 102-1 to communicate with the server 104 through text messages via SMS or email, or can present a graphical user interface on the display of the mobile device 102-1. Through the presentation module 312, a presenter or an instructor can hold question-answer series, quizzes, conduct surveys, or give presentations on various topics. The presentation module 312 either can transmit the questions, quizzes, presentations, etc. to the mobile device 102-1 and other mobile devices via messages or present them on displays on the mobile devices in an appropriate format. The presentation module 212 can also present the content on one more display devices such as projectors present at each location where participants of the session are gathered. The presentation module 312 also tracks responses from the mobile device 102-1 and other mobile devices participating in the session. The presentation module 312 can send a report message to each of the mobile devices participating in the session. The report message includes, but not limited to, a score report including marks obtained in a test or a quiz, correct responses for the questions asked during the session, and a consolidated performance chart comparing the marks obtained by all the users of the mobile devices participating the session.

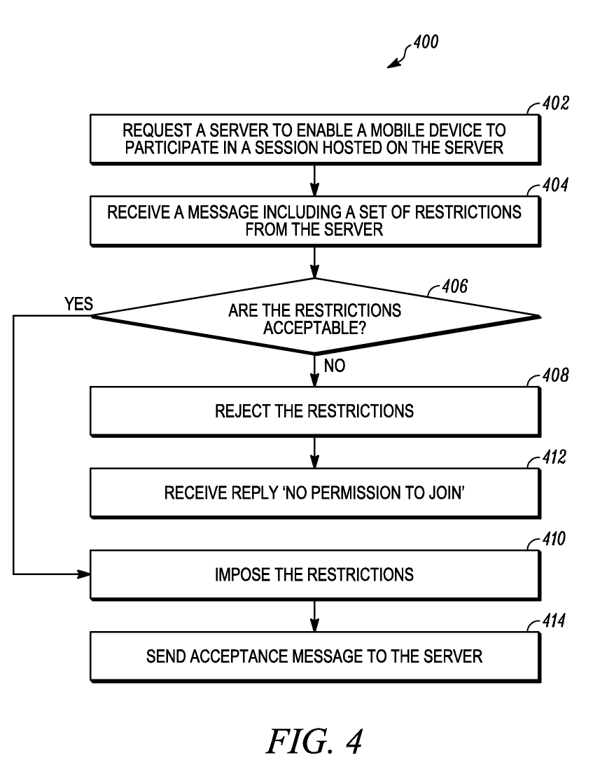

FIG. 4 is a flowchart of a method 400 for facilitating a mobile device to participate in a session hosted on a server. The method 400 is explained with reference to FIG. 1. At block 402, the mobile device 102-1 requests the server 104 to participate in a session hosted on the server 104. In one embodiment, the mobile device 102-1 sends a request message to the server 104 seeking permission to participate in the session. In response to the request message, the mobile device 102-1 receives an authentication message from the server 104 requesting for credentials of the user carrying the mobile device 102-1. The mobile device 102-1 sends the credentials such as username and password to the server 104, and the server 104 authenticates the mobile device 102-1 based on the credentials. In an alternate embodiment, the mobile device 102-1 and the server 104 mutually authenticate each other based on one or more authentication parameters such as device ID, server ID, passwords, and the like.

At block 404, after the authentication, the mobile device 102-1 receives a message including a set of restrictions from the server 104. In one embodiment, the set of restrictions received from the server 104 includes restrictions on usage of one or more applications residing on the mobile device 102-1.

At block 406, the mobile device 102-1 determines whether the restrictions are acceptable. In one embodiment, the user carrying the mobile device 102-1 reviews the received set of restrictions and decides whether to accept or reject the restrictions. If the user decides that the restrictions are not acceptable, the mobile device 102-1 follows instructions at block 408. On the other hand, if the user decides that the restrictions are acceptable, the mobile device 102-1 follows instructions at block 410.

At block 408, the mobile device 102-1 rejects the restrictions. In one embodiment, upon determining that the restrictions are not acceptable, the mobile device 102-1 sends a rejection message to the server 104. In response to the rejection message, the mobile device 102-1 receives a reply from server 104 stating that the mobile device 102-1 has no permission to join the session, as indicated by block 412.

At block 410, the mobile device 102-1 imposes the restrictions on the one or more applications residing on it. In one embodiment, upon determining that the restrictions are acceptable, the mobile device 102-1 imposes the restrictions on the one or more application residing on it based on the received set of restrictions. After imposing the restrictions, the mobile device 102-1 sends an acceptance message to the server 104, as indicated by block 414. In one embodiment, the user may not be able to send the acceptance message to the server 104 unless the mobile device 102-1 imposes all the restrictions as received from the server 104. In response to the acceptance message, the mobile device 102-1 receives an authorization message from the server 104, permitting the mobile device 102-1 to participate in the session.

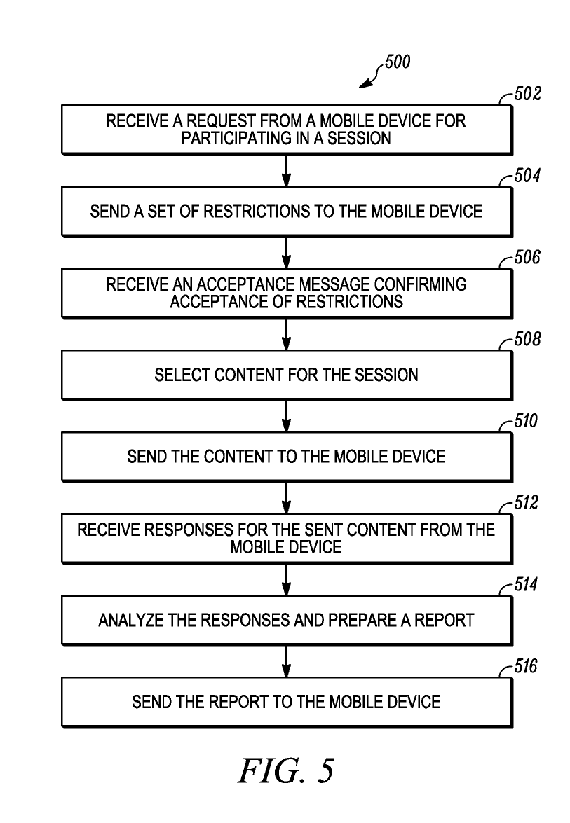

FIG. 5 is a flowchart of a method 500 for facilitating a server to impose restrictions on a mobile device to enable the mobile device to participate in a session. The method 500 is explained with reference to FIG. 1. At block 502, the server 104 receives a request from a mobile device to participate in the session hosted on the server 104. In one embodiment, the server 104 receives a request message from the mobile device 102-1 seeking permission to participate in the session. The server 104 sends an authentication message to the mobile device 102-1, directing the mobile device 102-1 to send credentials of the user carrying the mobile device 102-1. The server 104 authenticates the user based on the credentials received from the mobile device 102-1. In an alternate embodiment, the server 104 sends invitation an alert to the mobile device 102-1 to participate in the session.

At block 504, the server 104 sends a set of restrictions to the mobile device. In one embodiment, after authentication, server 104 sends a message including a set of restrictions to the mobile device 102-1. The set of restrictions includes restrictions to be imposed on one or more applications residing in the mobile device 102-1. The server 104 requires that the mobile device 102-1 impose the restrictions before participating in the session.

At block 506, the server 104 receives an acceptance message confirming the acceptance of restrictions. In one embodiment, the server 104 receives an acceptance message from the mobile device 102-1, which confirms that the mobile device 102-1 has accepted the restrictions and imposed the restrictions on the one or more applications residing in the mobile device 102-1. After receiving the acceptance message, the server 104 sends an authorization message to the mobile server 102-1. The authorization message includes a unique ID that enables the mobile device 102-1 to log on to the server 104 for participating the session. The server 104 receives a rejection message from the mobile device 102-1, if the mobile device 102-1 does not accept the restrictions.

At block 508, the server 104 selects content for the session. In one embodiment, the server 104 can select the content from the presenter devices 106. The presenters or instructors operating the presenter devices 106 upload content relevant for the session on the presenter devices 106. The server 104 can also select relevant content from its own database.

At block 510, the server 104 sends the selected content to the mobile devices participating in the session. In one embodiment, after selecting the content for the session, the server 104 sends the content to the mobile device 102-1. The server 104 can either send the content to the mobile device 102-1 through messages or present the content through a graphical user interface on to the display of the mobile device 102-1.

At block 512, the server 104 receives responses from the mobile devices participating in the session. In one embodiment, the server 104 receives responses from the mobile device 102-1 for the content sent by the server 104. The responses may include answers to questions asked during the session, responses to surveys, queries from the user carrying the mobile device 102-1, and the like.

At block 514, the server 104 analyzes the responses received from the mobile devices and prepares a report. In one embodiment, after receiving the responses from the mobile device 102-1, the server 104 analyzes the responses and calculates scores or marks obtained by the user of the mobile device 102-1. The server 104 prepares a report for the mobile device 102-1. The report can include a score report, correct responses to the questions asked during the session, and a consolidated performance report comparing the performance of the user of mobile device 102-1 with users of other mobile devices participating in the session.

At block 516, the server 104 sends the report to the mobile devices. In one embodiment, the server 104 sends a report message to the mobile device 102-1. The report message includes the report prepared for the mobile device 102-1 (as described in block 514). The report message can also include responses for the queries raised by the user of the mobile device 102-1 during the session.

In the foregoing specification, specific embodiments of the present disclosure have been described. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

We claim:

1. A method for facilitating a mobile device to participate in a session hosted on a server, the method comprising:
requesting the server to enable the mobile device to participate in the session;
receiving a set of restrictions from the server in response to the request, wherein the set of restrictions comprises one or more restrictions to be imposed on one or more applications residing in the mobile device;
determining whether to accept or reject the received set of restrictions;
sending an acceptance message to the server upon determining to accept the received set of restrictions; and
obtaining access to the session hosted on the server.

2. The method of claim 1, further comprising mutually authenticating with the server based on one or more authentication parameters.

3. The method of claim 1, further comprising restricting usage of the one or more applications residing in the mobile device.

4. The method of claim 1, wherein obtaining access to the session comprises receiving an authorization message from the server.

5. The method of claim 4, wherein the authorization message comprises a unique identification (ID) assigned to the mobile device by the server.

6. The method of claim 1, further comprising sending a request to the server to disable access to the session and remove the restrictions imposed on the mobile device.

7. The method of claim 1, wherein the session hosted on the server has content comprising at least one of a question-answer series, a quiz, a survey, or a presentation.

8. The method of claim 1, wherein the set of restrictions is based on type of the session hosted on the server.

9. The method of claim 1, wherein the mobile device communicates with the server wirelessly.

10. A method for facilitating a server to enable one or more mobile devices to participate in a session hosted on the server, the method comprising:
receiving one or more requests from the one or more mobile devices for participating in the session hosted on the server;
sending a set of restrictions to the one or more mobile devices requesting to participate in the session;
receiving one or more acceptance messages from the one or more mobile devices accepting the set of restrictions;
selecting content for the session hosted on the server; and
sending the selected content to the one or more mobile devices based on the received acceptance messages.

11. The method of claim 10, further comprising sending an invitation alert to participate in the session to the one or more mobile devices.

12. The method of claim 10, further comprising mutually authenticating with the requesting mobile devices based on one or more authentication parameters.

13. The method of claim 10, wherein the set of restrictions is based on the content of the session hosted on the server.

14. The method of claim 10, wherein the content includes at least one of a question-answer series, a quiz, a survey, or a presentation.

15. The method of claim 10, further comprising assigning a unique identification (ID) to each of the mobile device participating in the session.

16. The method of claim 10, further comprising analyzing messages received from the one or more mobile devices in response to the sent content.

17. The method of claim 10, further comprising sending a report message to the one or more mobile devices, wherein the report message includes at least one of a score report, a correct response, or a consolidated performance chart.
